(19) United States
(12) Patent Application Publication
(10) Pub. No.: US 2018/0051746 A1
(43) Pub. Date: Feb. 22, 2018

(54) OPERATING MECHANISM FOR MOVABLE COMPARTMENT

(71) Applicant: LIPPERT COMPONENTS, INC., Elkhart, IN (US)

(72) Inventor: Nicholas Cornett, Granger, IN (US)

(21) Appl. No.: 15/643,143

(22) Filed: Jul. 6, 2017

Related U.S. Application Data
(60) Provisional application No. 62/376,211, filed on Aug. 17, 2016.

(51) Int. Cl. F16C 29/00; F16M 11/18

(52) U.S. Cl. CPC F16C 29/005; B60P 3/34; F16M 11/18

(57) ABSTRACT

An operating mechanism for reciprocating a movable compartment through an opening in a wall of structure includes a shell, a slide received within the shell, and a linear actuator connected between the slide and the shell.

### CROSS-REFERENCE TO RELATED APPLICATION

This application claims benefit under 35 U.S.C. §119 of U.S. Provisional Patent Application No. 62/376,211, filed on Aug. 17, 2016, and incorporates by reference the disclosure thereof in its entirety.

### BACKGROUND AND SUMMARY OF THE DISCLOSURE

The disclosure is directed to an operating mechanism for reciprocating a movable compartment, for example, a slide out room, through an opening in a wall of a structure, for example, a recreational vehicle.

### BRIEF DESCRIPTION OF THE DRAWINGS

FIG. 1 is an upper perspective view of an apparatus for reciprocating a movable room through an opening in a wall of a structure according to the present disclosure, the apparatus including a shell and a slide, the slide fully retracted within the shell;

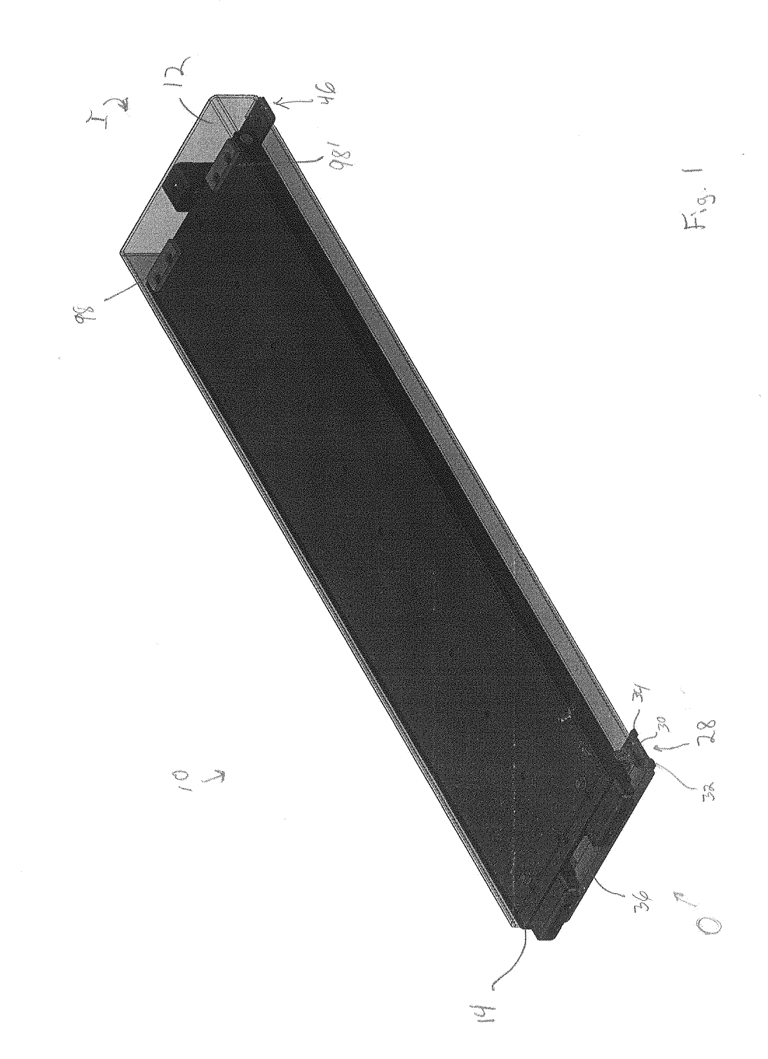

FIG. 2 is a lower perspective view of the apparatus of FIG. 1 with the slide partially extended from the shell;

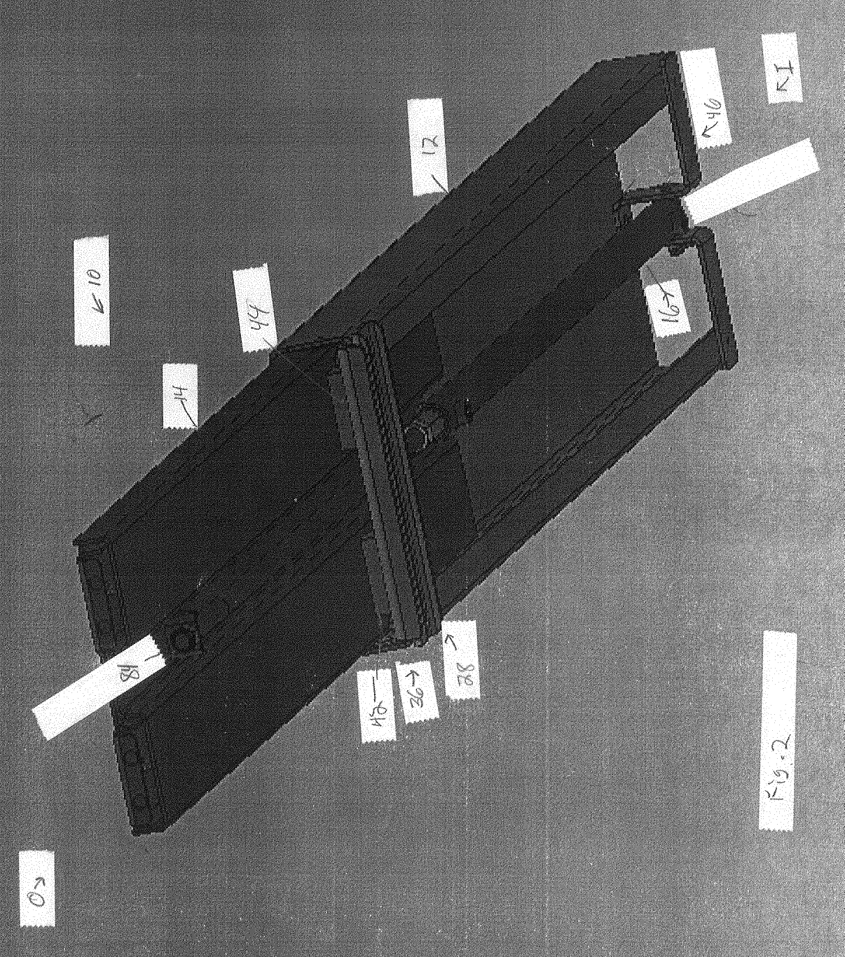

FIG. 3 is a perspective view of a shell of the slide of the apparatus of FIG. 1;

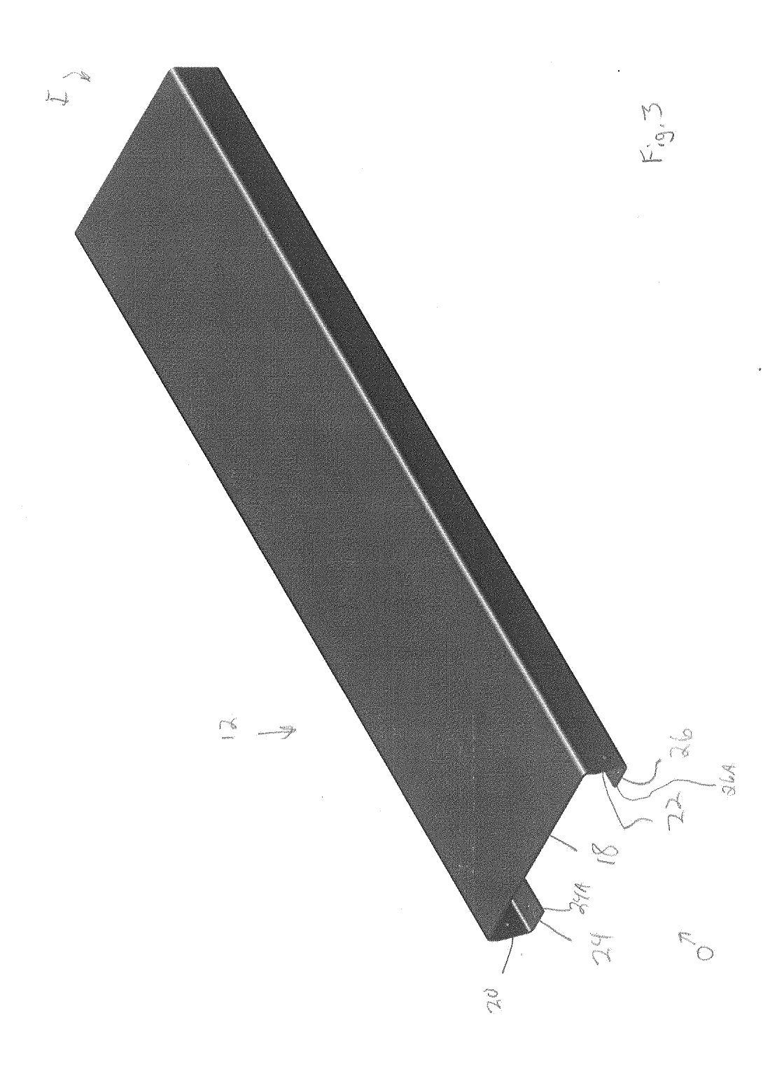

FIG. 4 is a perspective view of a slide frame of the slide of the apparatus of FIG. 1;

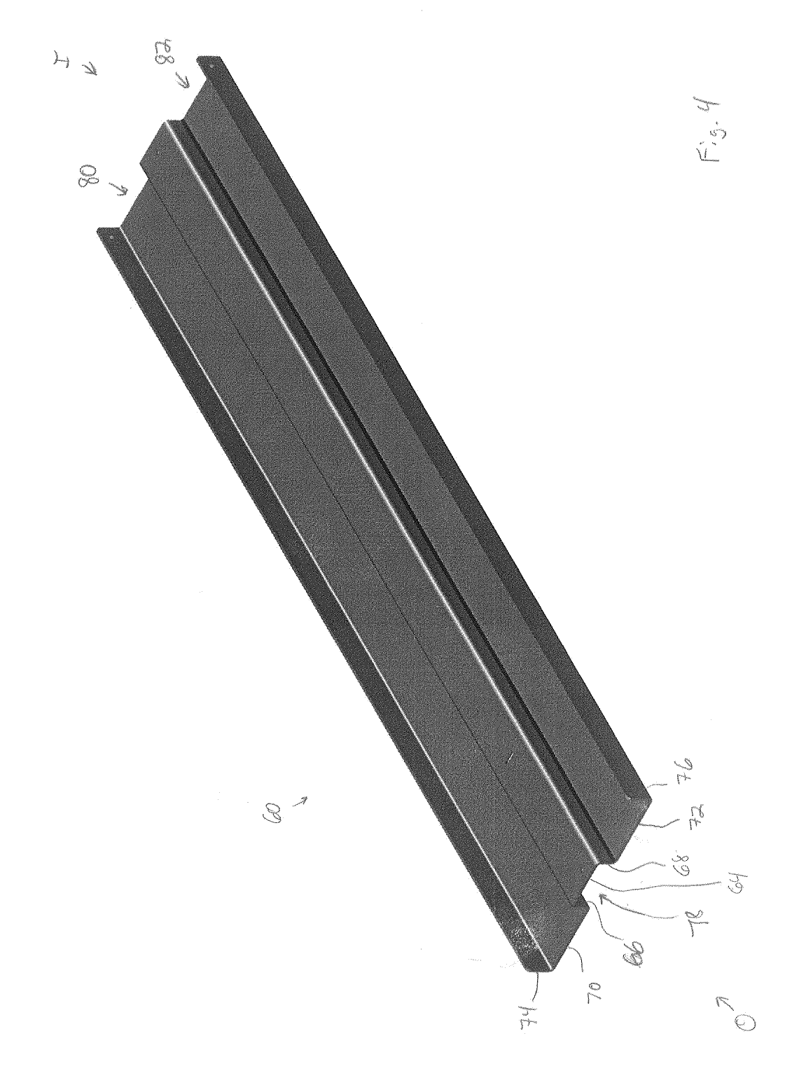

FIG. 5 is a perspective view of a slide cover of the slide of the apparatus of FIG. 1;

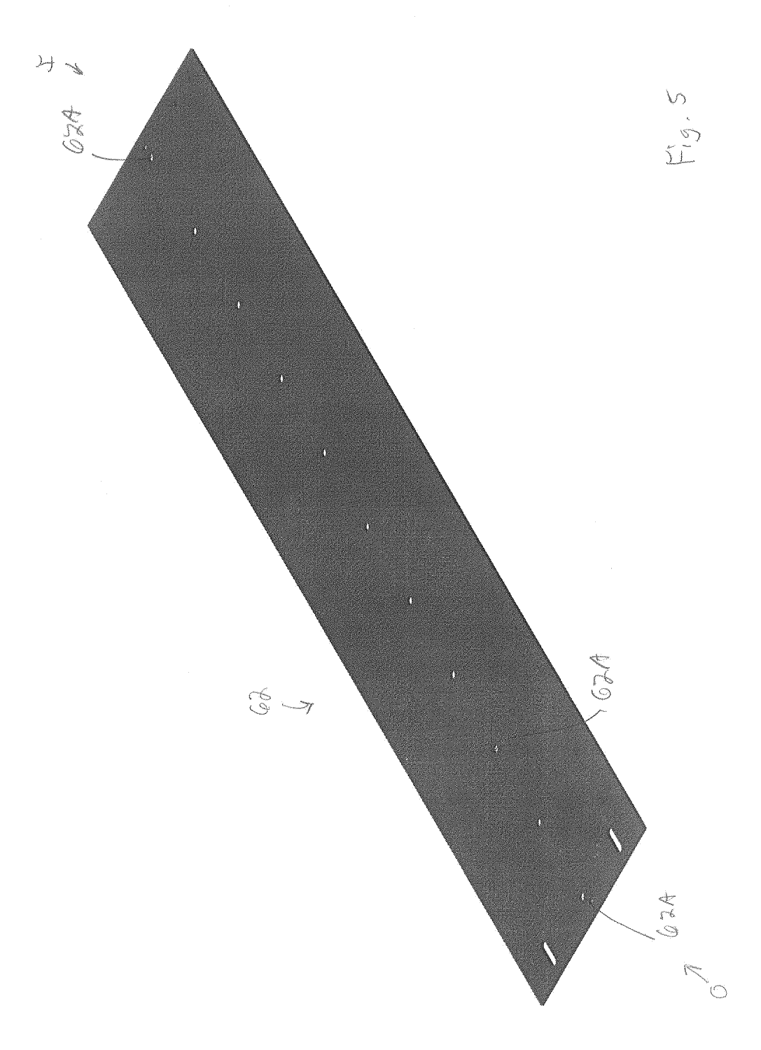

FIG. 6 is a perspective view of a first cross member of the apparatus of FIG. 1;

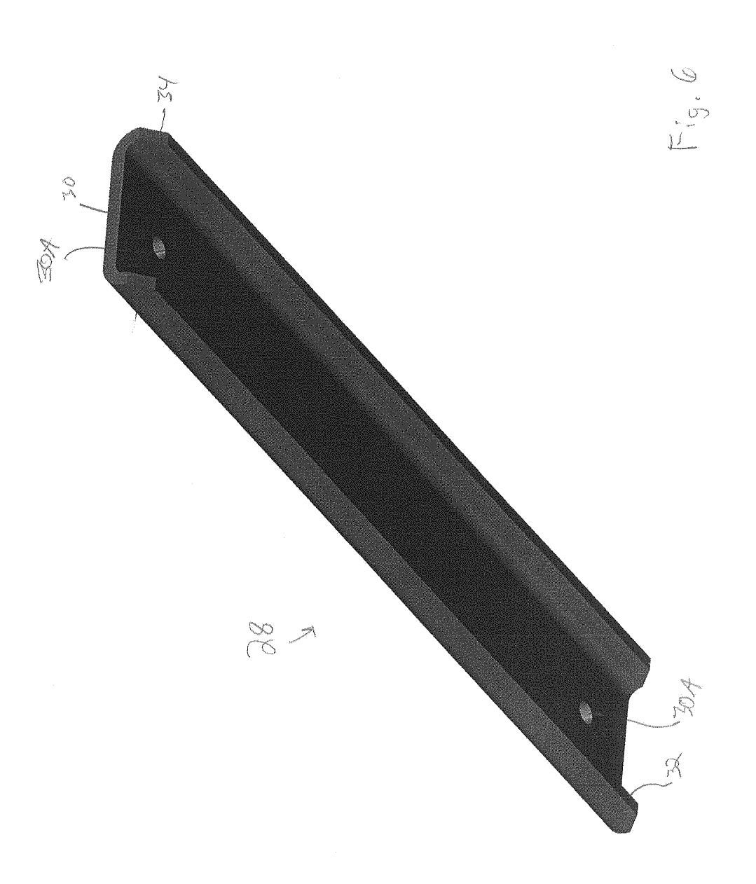

FIG. 7 is a perspective view of a glide block bracket of the apparatus of FIG. 1;

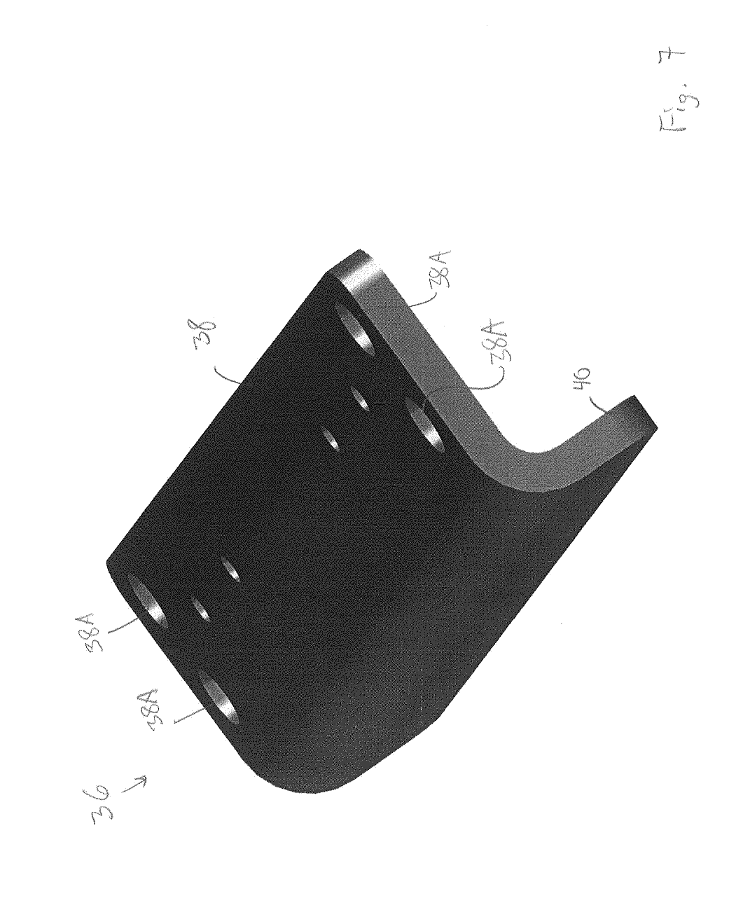

FIG. 8 is a perspective view of a second cross member of the apparatus of FIG. 1;

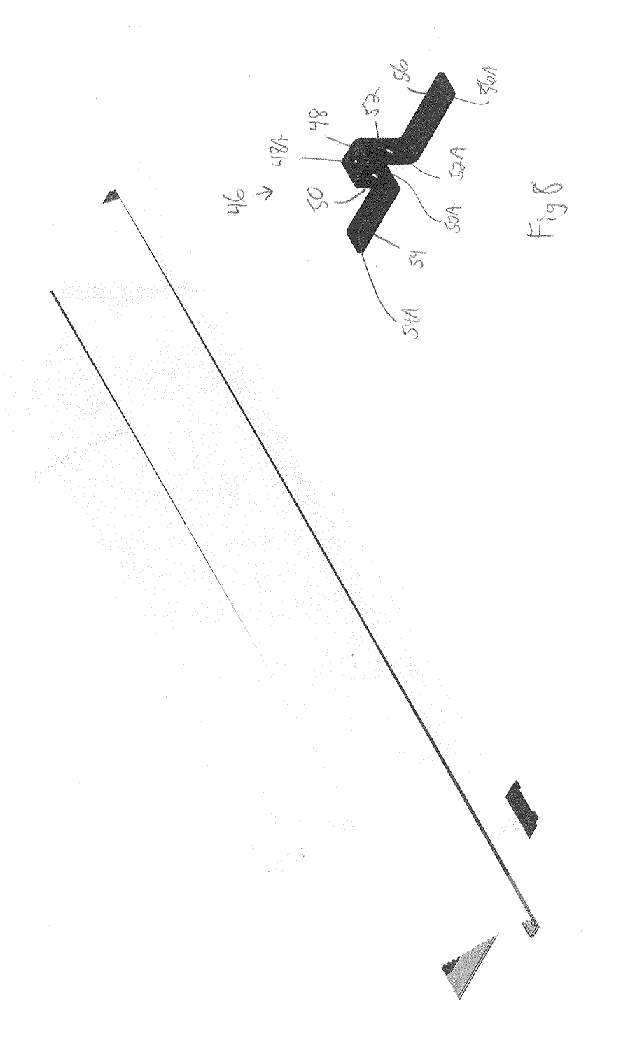

FIG. 9 is a perspective view of a room attachment bracket of the apparatus of FIG. 1;

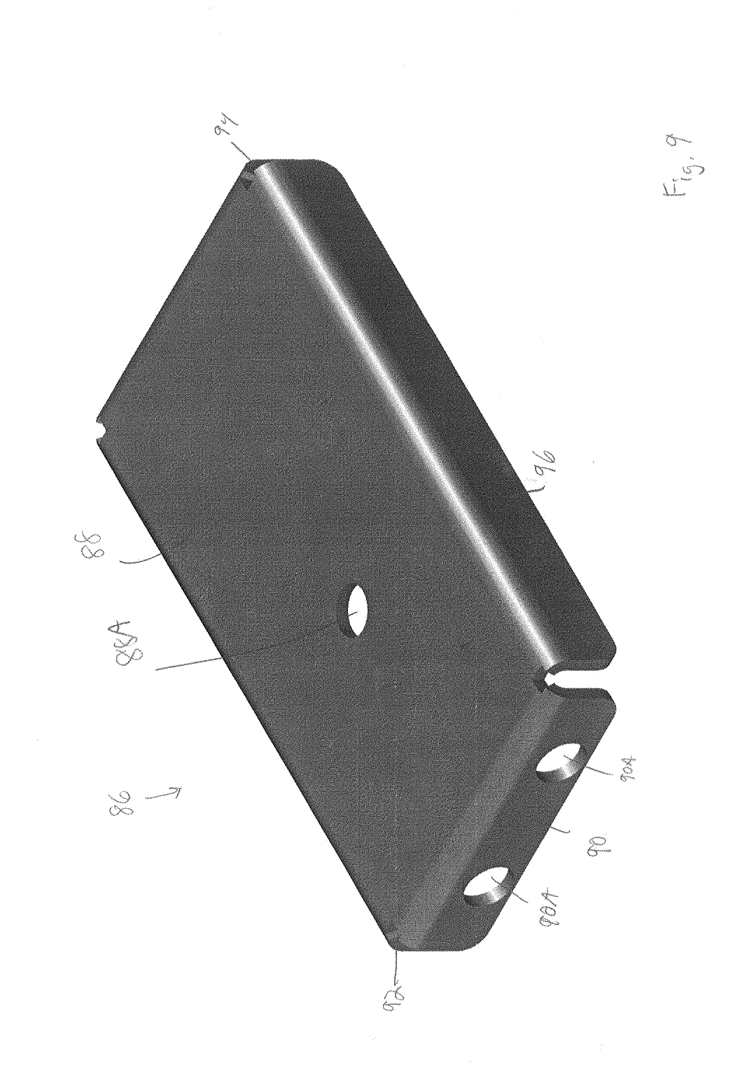

FIG. 10 is an end view of the apparatus of FIG. 1;

FIG. 11 is another upper perspective view of the apparatus of FIG. 1 in phantom;

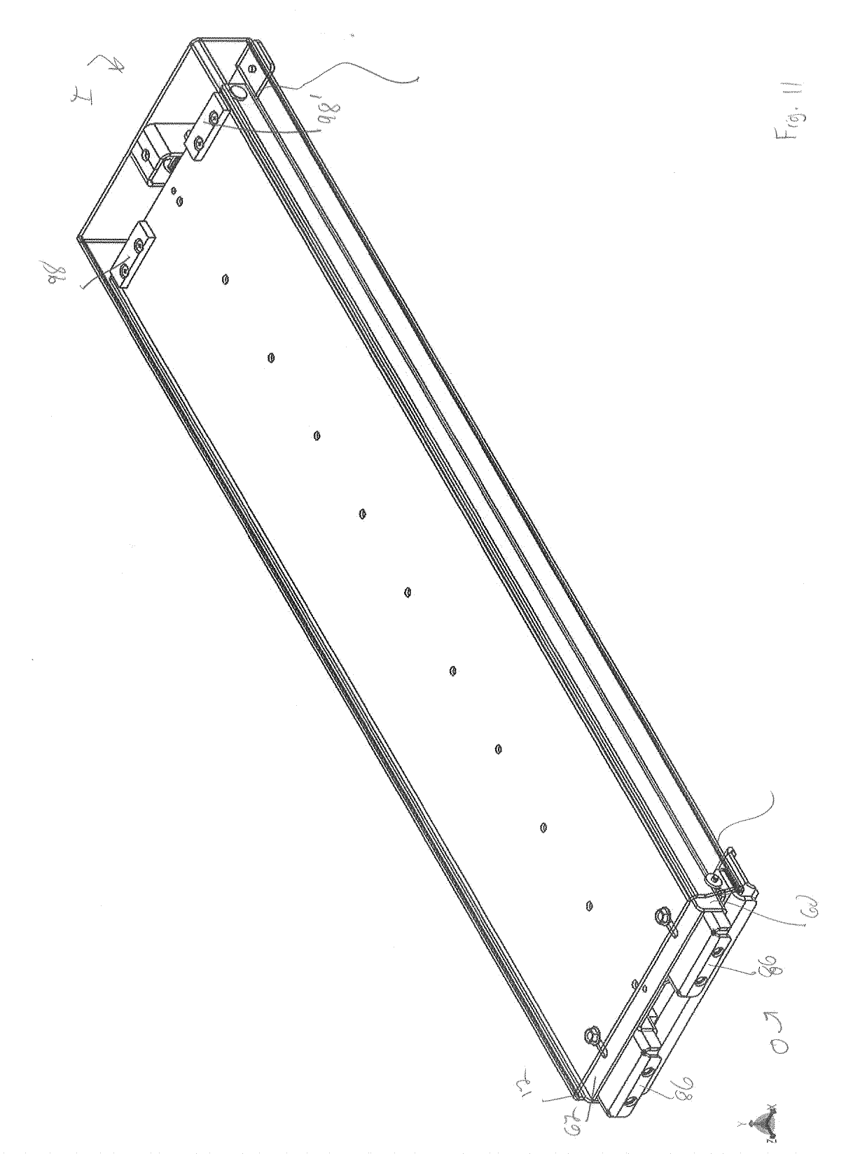

FIG. 12 is a side elevation view of the apparatus of FIG. 1 with the shell removed for clarity;

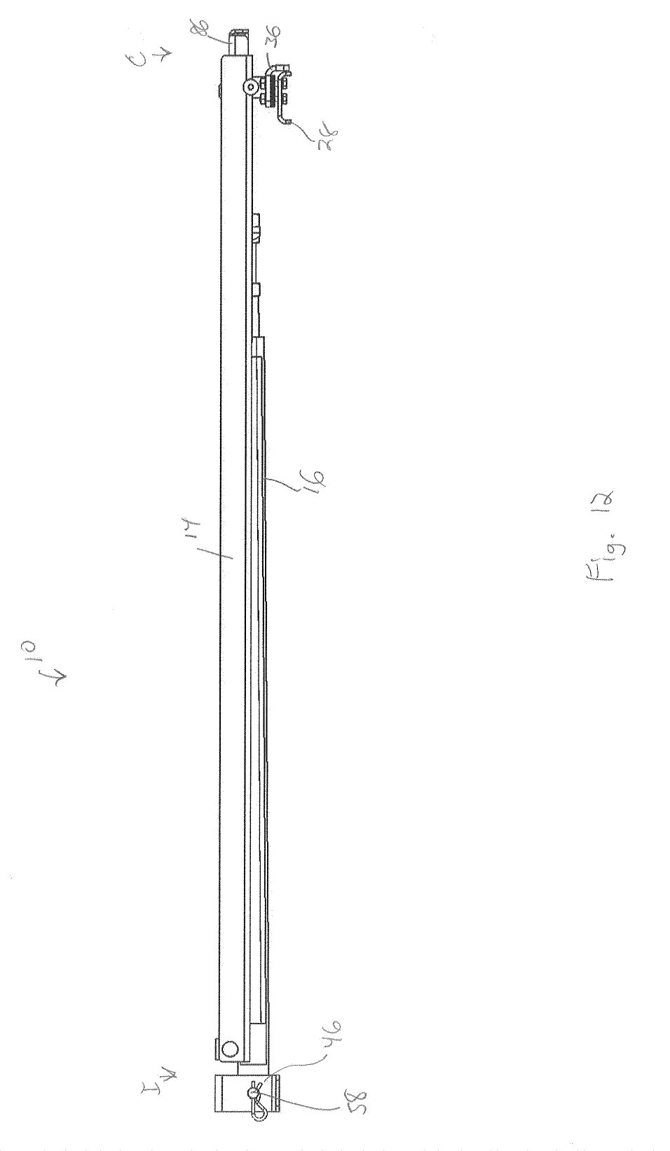

FIG. 13 is a perspective view of the apparatus of FIG. 1 with the shell removed for clarity;

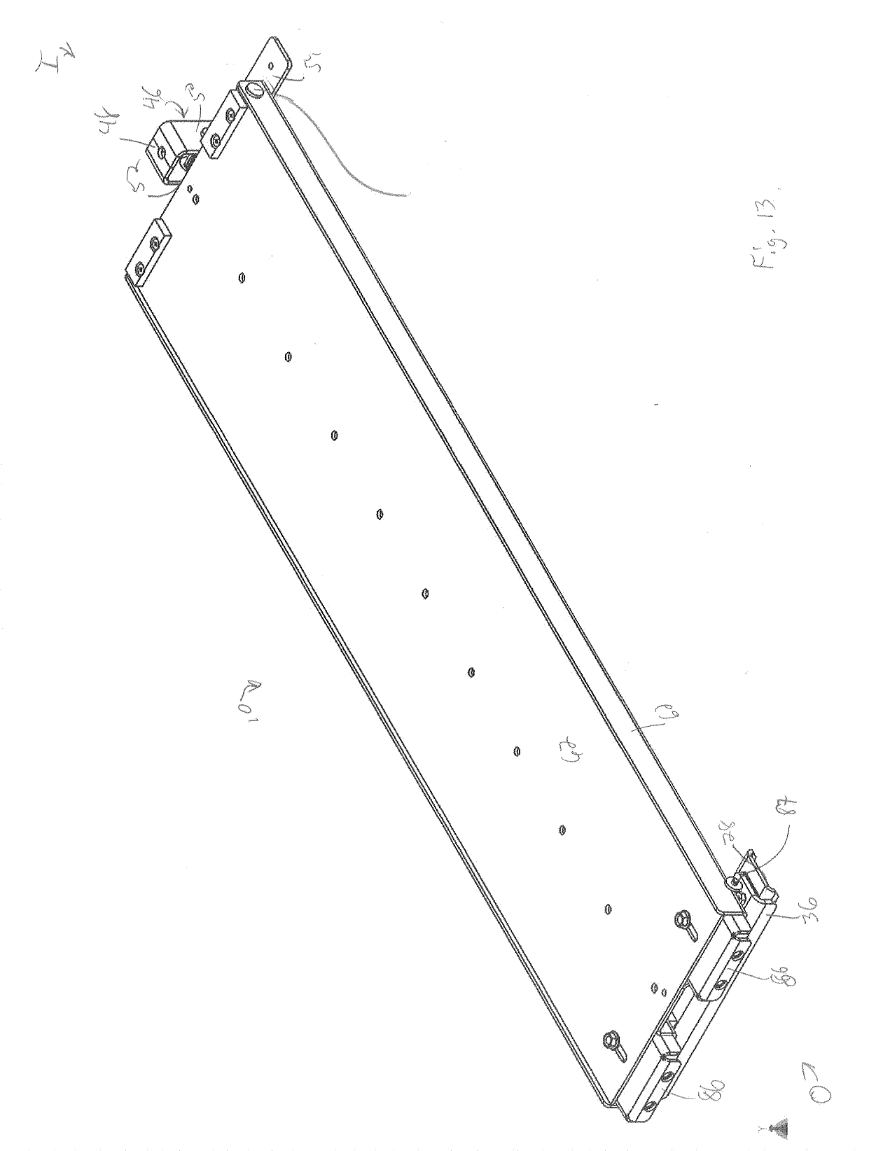

FIG. 14 is a sectional perspective view of the apparatus of FIG. 12; and

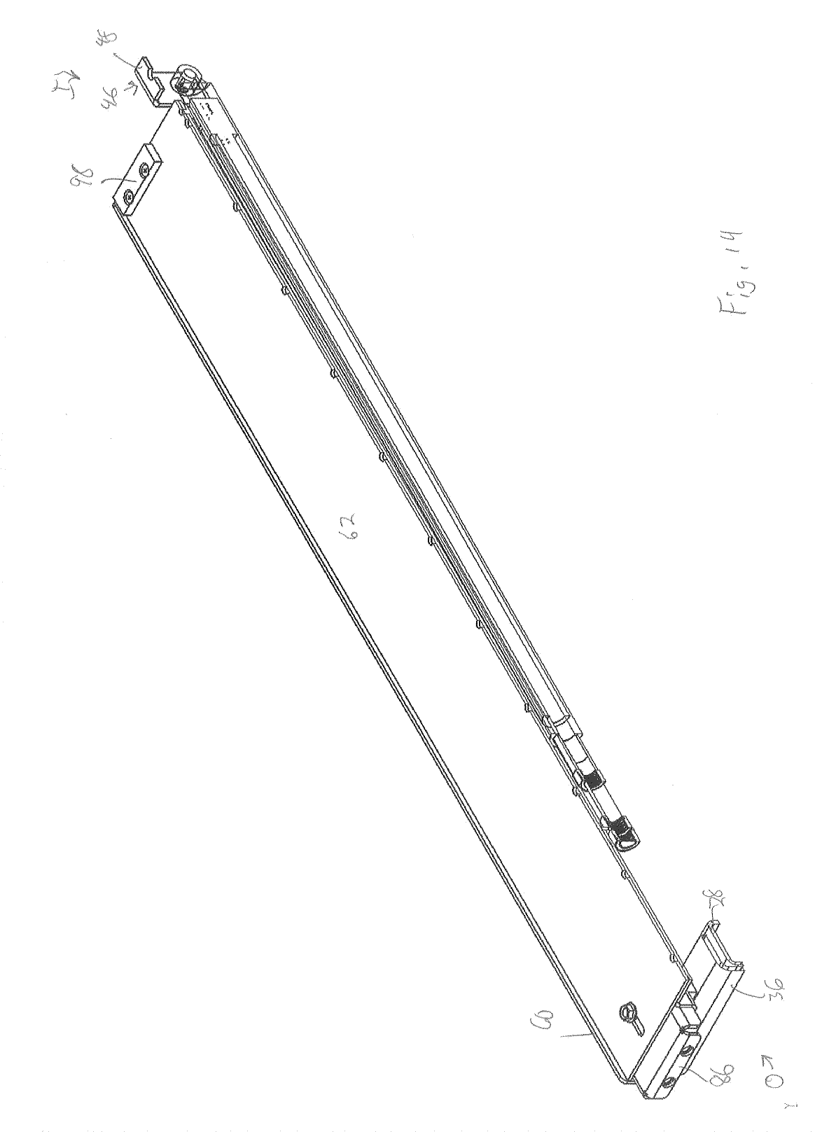

FIG. 15 is another sectional perspective view of the apparatus of FIG. 12;

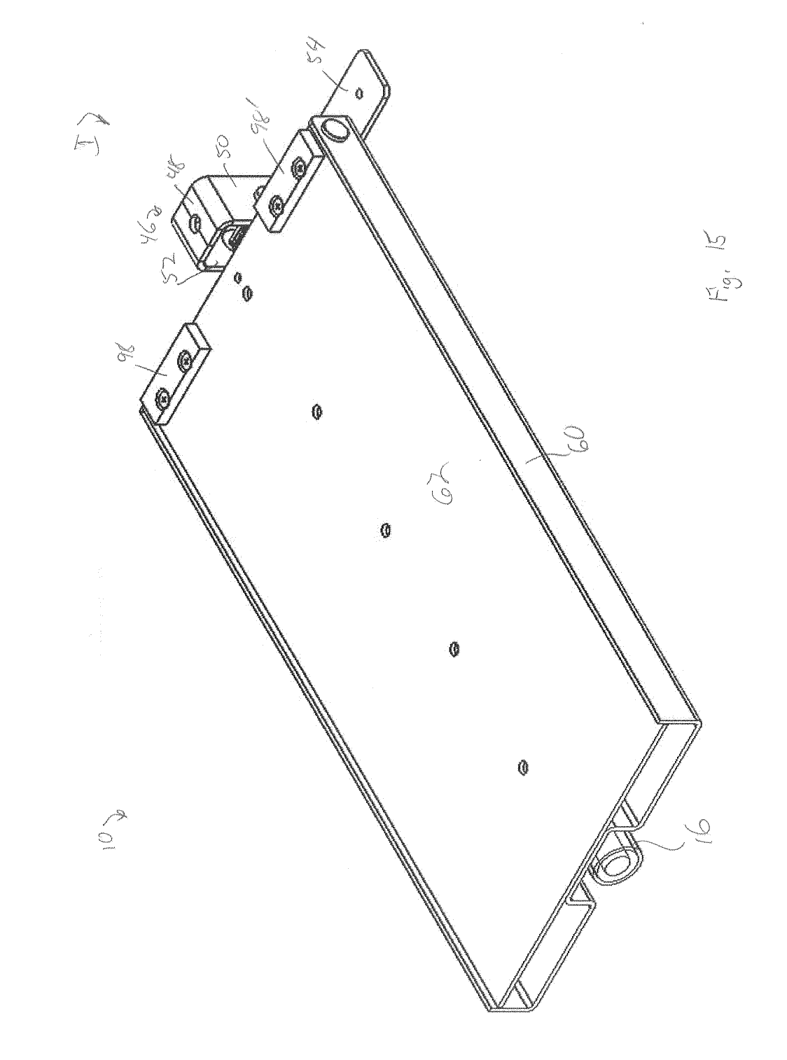

### DETAILED DESCRIPTION OF THE DRAWINGS

The drawings show an illustrative embodiment of an apparatus 10 for reciprocating a movable compartment, for example, a slide out room (not shown), with respect to a structure (not shown), for example, a recreational vehicle, in which the movable compartment may be installed. The apparatus has a first (or outboard) end O and a second (or inner) end I.

The apparatus 10 includes an elongated shell 12, an elongated slide 14 slidingly engaged and received within with the shell, and an actuator 16 operably connected to the slide and the shell and operable to reciprocate the slide with respect to the shell. The shell 12 may be operably connected to the structure, and the slide 14 may be operably connected to the movable compartment. So connected, the apparatus 10 is operable to reciprocate the movable compartment with respect to the structure.

The shell 12 includes a web 18, a first flange 20 depending from a first side of the web, a second flange 22 depending from a second side of the web opposite the first side of the web, a first lip 24 extending from the first flange toward the second flange, and a second lip 26 extending from the second flange toward the first flange. As shown, the web 18 is generally planar; the first and second flanges 20, 22 are generally planar, perpendicular to the web, and parallel to each other; and the first and second lips 24, 26, are generally planar, coplanar with each other, and parallel to the web. The shell 12 has a first (or outboard) end O and a second (or inboard) end I.

A first (or outboard) cross member 28 is connected to the first lip 24 and the second lip 26 of the shell 12 near the first end of the shell. The first cross member 28 is shown as including an elongated web 30, a first flange 32 extending in a first direction from a first elongated edge of the web, and a second flange 34 extending in a second direction from a second elongated edge of the web. The first and second directions may be the same such that the first flange 32 is parallel to and opposite the second flange 34.

The first cross member 28 is shown as being connected to respective outer surfaces of the first lip 24 and the second lip 26 of the shell 12 by mechanical fasteners extending through corresponding apertures 30A, 24A, 26A in the web 30 of the first cross member and in the first lip and the second lip, respectively. In other embodiments, the first cross member 28 may be connected to respective inner surfaces of the first lip 24 and the second lip 26 or to another portion of the shell 12, and the first cross member may be connected to the shell by other means, for example, by welding.

A glide block bracket 36 is connected to the first lip 24 and the second lip 26 of the shell 12 near the first end of the shell. The guide block bracket 36 is shown as an elongated angle having a first leg 38 disposed within the shell 12 and parallel to the web of the shell, and a second leg 40 generally perpendicular to the first leg and extending away from the web of the shell 12. In other embodiments, the glide block bracket 36 may be configured in other ways.

The glide block bracket 36 is shown as being connected to inner surfaces of the first lip 24 and the second lip 26 of the shell 12 by mechanical fasteners extending through corresponding apertures 38A, 24A, 26A in the glide block bracket and in the first lip and the second lip, respectively. Indeed, the glide block bracket 36 is shown as being connected to the first lip 24 and the second lip 26 using the same fasteners connecting the first cross member 28 to the first lip and the second lip. So connected, the first lip 24 and the second lip 26 are sandwiched between the first cross member 28 and the glide block bracket 36. In other embodiments, the glide block bracket 36 may be connected to outer surfaces of the first lip 24 and the second lip 26 or to another portion of the shell 12, it may be connected to the shell independent of the first cross member 28, and it may be connected by other means, for example, by welding.

First and second glide blocks 42, 44 are disposed on first surface of the glide block bracket 36 facing the web 18 of the shell 12. The first and second glide blocks 42, 44 may be made of DELRIN® plastic or another suitable material capable of bearing a high load under sliding engagement. The first and second glide blocks 42, 44 may be removably attached to the glide block bracket 36 to facilitate their replacement. For example, a head or another portion of at least one mechanical fastener (not shown) may be embedded within each of the first and second glide blocks 42, 44. A shank of the mechanical fastener (not shown) may extend through a corresponding aperture in the glide block bracket 36 and engage with a mating mechanical fastener or otherwise be secured to the glide block bracket.

One or more shims may be installed between the first and second glide blocks 42, 44 and the glide block bracket 36, or between the glide block bracket and the first cross member 28.

A second (or inboard) cross member 46 is connected to the first lip 24 and the second lip 26 of the shell 12 near the second end of the shell 12. The second cross member 46 is configured as a flying U, having a web 48, first and second flanges 50, 52 extending in the same direction from opposite ends of the web, and first and second lips 54, 56 extending outwardly in opposite directions from the ends of the first and second flanges opposite the web. The first and second lips 54, 56 of the second cross member 46 may be connected to outer surfaces of the first lip 24 and the second lip 26 of the shell 12. The web 48 of the second cross member 46 may be attached to the web 18 of the shell 12. The second cross member 46 may be attached to the shell 12, for example, using mechanical fasteners or by welding. The web 48 may define an aperture 48A. The first and second flanges 50, 52 of the second cross member 46 may define collinear apertures 50A, 52A there through configured to receive a pin 58 extending there through, as will be discussed further below. The second cross member may be made in two pieces, the two pieces being symmetrical about a line bisecting the web 48 and parallel to the first and second flanges 50, 52.

The first and second cross members 28, 46 may further be configured as mounting brackets for attachment to a structure, for example, to a floor of the structure. For example, the web 30 of the first cross member 28 may define one or more apertures (not shown) for receiving mechanical fasteners engageable with the structure. Similarly, the first and second lips 54, 56 of the second cross member 46 may define respective apertures 54A, 56A for receiving mechanical fasteners engageable with the structure. Alternatively, separate mounting brackets or other means (not shown) may be provided for attaching the shell 12 to the structure.

The slide 14 includes a slide frame 60 and a cover 62. Each of the slide frame 60 and the cover 62 has a first (or outboard) end O and a second (or inboard) end I. The slide frame 60 is an elongated structure having a generally W-shaped cross section. More specifically, the slide frame 60 includes a first web 64, a first flange 66 extending in a first direction from the first web, and a second flange 68 extending in a second direction from the first web. The first direction and the second direction may be identical such that the second flange 68 is parallel to the first flange 66. The slide frame 60 also includes a second web 70 extending in a third direction from an end of the first flange 66 opposite the first web 60, the third direction generally parallel to the plane of the first web 64, and a third web 72 extending in a fourth direction from an end of the second flange 68 opposite the first web 64, the fourth direction generally parallel to and opposite the third direction. The slide frame 60 further includes a third flange 74 extending in a fifth direction from an end of the second web 70 opposite the first flange 66, the fifth direction general perpendicular to the third direction, and a fourth flange 76 extending in a sixth direction from an end of the third web 72 opposite the second flange 68, the sixth direction general perpendicular to the fourth direction. As shown, the first, second, and third webs 64, 70, 72 are generally planar and parallel to teach other, the second and third webs 70, 72 are co-planar with other, and the first, second, third, and fourth flanges 66, 68, 74. 76 are generally planar and parallel to each other and perpendicular to the first, second, and third webs 64, 70, 72.

The first web 64, the first flange 66, and the second flange 68 cooperate to define a first channel 78. The second web 70, the first flange 66 and the third flange 74 cooperate to define a second channel 80. The third web 72, the second flange 68 and the fourth flange 76 cooperate to define a third channel 82.

An actuator mounting bracket 84 is disposed in the first channel 78. The actuator mounting bracket 84 may be embodied as a plate secured to the first web 64, first flange 66, and/or second flange 68 of the slide frame. The actuator mounting bracket 84 may be configured to securely engage with a first (or outboard) end of the actuator 16.

The cover 62 is a generally rectangular, thin sheet of material configured for attachment to the slide frame 60 so as to cover the second channel 80 and the third channel 82. The cover 62 may be attached to the slide frame 60, for example, using mechanical fasteners extending through corresponding apertures in the cover and the first web 64 of the slide frame. In an embodiment, the cover 62 could be welded to the slide frame 60. For example, the cover 62 could be spot welded to the first web 64 and/or welded to the third flange 74 and the fourth flange 76.

A first compartment (or room) attachment bracket 86 is disposed in the second channel 80 proximate the first end thereof. The first room attachment bracket 86 includes a rectangular web 88, a first flange 90 extending in a first direction from a first edge of the web, a second flange 92 extending in the first direction from a second edge of the web, a third flange 94 extending in the first direction from a third edge of the web, and a fourth flange 96 extending in the first direction from the fourth edge of the web. The first room attachment bracket 86 is secured to the slide 14. In an embodiment, the web 88 of the first room attachment bracket 86 may define an aperture 88A alignable with a corresponding aperture 62A in the cover 62. The first room attachment bracket 86 may be secured to the cover 62 by a mechanical fastener extending through the corresponding apertures therein. The first flange 90 of the room attachment bracket 86 may define one or more apertures 90A configured to receive fasteners for attaching the room attachment bracket to the structure.

A second compartment (or room) attachment bracket 86′ having a similar structure may be disposed in the third channel 82 proximate the first end thereof in a similar manner.

Third and fourth glide blocks 98, 98′ are attached to an upper surface of the cover 62 proximate the inboard end I of the slide 14. The third and fourth glide blocks 98, 98′ may be similar to the first and second glide blocks 42, 44, and they may be attached to the cover 62 in a manner similar to that in which the first and second glide blocks are attached to the glide block bracket 36.

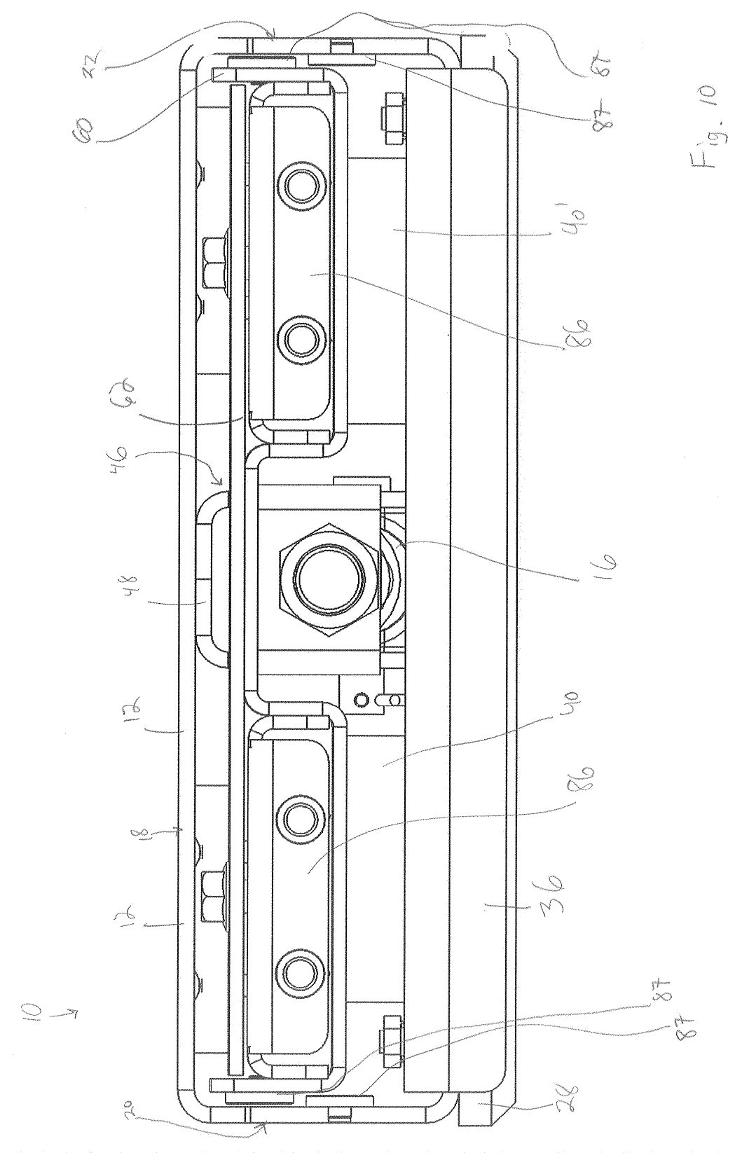

Wear buttons 87 may be attached to one or the other (or both) of side surfaces of the shell 12 and the slide 14 to further facilitate sliding of the slide with respect to the shell. For example, as best shown in FIG. 10, wear buttons 87 may be attached to outward-facing side surfaces of the slide 14 and inward-facing side surfaces of the shell 12. The wear buttons 87 attached to the slide 14 may slidingly engage with complementary facing surfaces of the shell 12, and the wear buttons attached to the shell may slidingly engage with complementary facing surfaces of the slide.

The slide 14 is slidably received within the shell 12 so that the second and third webs 70, 72 of the slide are slidably supported by the first and second glide blocks 42, 44, and such that the third and fourth glide blocks 98, 98′ are slidably engaged or engageable with the inner surface of the web 18 of the shell 12. The actuator 16 is connected at a first end to the actuator mounting bracket 84 of the slide 14, and at a second end to the second cross member 46. More specifically, the actuator 16 is shown as a linear actuator, for example, a hydraulic actuator comprising a hydraulic cylinder, a piston slidably received within the cylinder, and a piston rod extending from the piston and out of the cylinder. The free end of the piston rod may be threaded. The threaded portion may be attached to the actuator mounting bracket 84. The cylinder may include a boss at the free end thereof, the boss defining an aperture there through. The boss may be disposed between the first and second flanges 50, 52 with the aperture thereof aligned with apertures 50A, 52A of the first and second flanges of the second cross member 46, and the actuator pin 58 may be inserted through the respective apertures to attach the actuator to the second cross member. Alternatively, the actuator 16 could be connected between the shell 12 and the slide 14 in other ways.

The shell 12 may be attached, for example, to the floor of a structure (not shown). A slidable compartment may be attached to the slide 14 via the room attachment brackets 86, 86′. The weight of the room bearing on the room attachment brackets 86, 86′ would tend to force the second and third webs of the slide 14 against the first and second glide blocks, and it also would tend to force the third and fourth glide blocks against the web of the shell 12.

In use, the actuator 16 may be selectively extended and retracted. For example, the actuator 16 may be extended to thereby extend the room from the structure. Similarly, the actuator 16 may be retracted, thereby retracting the room toward the interior of the structure. As the actuator 16 is extended and retracted, the second and third webs 70, 72 of the slide frame 60 slide against the first and second glide blocks 42, 44, and the third and fourth glide blocks 98, 98′ slide against the web of the shell 12. In the event any of the glide blocks wears excessively through use, it may be replaced as set forth above.

The apparatus 10 generally may be made of steel or another suitable material unless otherwise specified.

The embodiment shown and described herein is illustrative and may be modified to the greatest extent possible while remaining within the scope of the appended claims.

1. An apparatus for reciprocating a slidable compartment through an opening in a wall of a structure having a floor, the mechanism comprising:
a shell, the shell comprising a web, a first flange depending from a first side of the web, a second flange depending from a second side of the web opposite the first side of the web, a first lip extending from the first flange toward the second flange, and a second lip extending from the second flange toward the first flange;
a slide slidingly and telescopically engaged within the shell, the slide comprising:
a first web and first and second flanges extending in a downward direction from opposite sides of the first web, the first web, the first flange, and the second flange cooperating to define a first open channel;
a second web extending from the first flange in a direction laterally outward from the first channel, and a third flange extending in an upward direction from the second web, the second web, the first flange, and the third flange cooperating to define a second open channel; and
a third web extending from the second flange in a direction laterally outward from the first channel, and a fourth flange extending in an upward direction from the third web, the third web, the second flange, and the fourth flange cooperating to define a third open channel; and
a linear actuator operably connected between the shell and the slide, the linear actuator operable to reciprocate the slide with respect to the shell.

2. The apparatus of claim 1 further comprising a first cross member connected to the shell proximate a first end of the shell.

3. The apparatus of claim 2, the first cross member connected to the first lip and the second lip.

4. The apparatus of claim 2 further comprising a second cross member connected to the shell proximate a second end of the shell.

5. The apparatus of claim 4, the second cross member connected to the first lip and the second lip.

6. The apparatus of claim 5, the second cross member further connected to the web.

7. The apparatus of claim 2 further comprising a glide block bracket connected to the shell and a glide block connected to the glide block bracket, the glide block slidingly engaged with the slide.

8. The apparatus of claim 7, the glide block slidingly engaged with the web of one of the first channel and the second channel of the slide.

9. The apparatus of claim 7 further comprising another glide block connected to the slide and slidingly engaged with the web of the shell.

10. The apparatus of claim 4 wherein a first end of the actuator is connected to the slide and a second end of the actuator is connected to the second cross member.

11. The apparatus of claim 1 further comprising a first room attachment bracket secured to the slide.

12. The apparatus of claim 11 wherein the first room attachment bracket is disposed within the second channel of the slide.

13. The apparatus of claim 11 further comprising a second room attachment bracket secured to the slide.

14. The apparatus of claim 13 wherein the second room attachment bracket is disposed within the third channel of the slide.

15. The apparatus of claim 1 wherein the first channel is open in a direction facing the shell and each of the second channel and the third channel is open in a direction facing away from the shell.
